(19) United States
(12) Patent Application Publication
(10) Pub. No.: US 2026/0322801 A1
(43) Pub. Date: Oct. 15, 2026

(54) SHARED ACCOUNT ACCESS VIA PHISHING-RESISTANT AUTHENTICATORS

(71) Applicant: OKTA, INC., SAN FRANCISCO, CA (US)

(72) Inventor: Johannes Stockmann, Woodinville, WA (US)

(21) Appl. No.: 19/465,638

(22) Filed: Jan. 30, 2026

Related U.S. Application Data
(60) Provisional application No. 63/751,748, filed on Jan. 30, 2025.

(51) Int. Cl. H04L 9/40

(52) U.S. Cl. CPC H04L 63/083; H04L 63/20

(57) ABSTRACT

An identity management system may manage access to a shared account. The system may receive, at an authorization server and from a user device, a request to access a shared account. The system may verify, via communications with an authenticator application on the user device, an identity of a user associated with the user device based on the request being for access to the shared account. The system may evaluate, at an access server of the system, a policy associated with the shared account. The system may generate, based on the policy indicating that the user is authorized to access the shared account, a signed assertion that the user is authorized to access the shared account, the signed assertion generated using a private key stored at a hardware vault of the system and associated with the shared account. The system may transmit the signed assertion to the user device.

### CROSS REFERENCE

The present Application for Patent claims priority to U.S. Provisional Patent Application No. 63/751,748 by Johannes Stockmann entitled “SHARED ACCOUNT ACCESS VIA PHISHING-RESISTANT AUTHENTICATORS,” filed Jan. 30, 2025, assigned to the assignee hereof, and expressly incorporated by reference in its entirety herein.

### FIELD OF TECHNOLOGY

The present disclosure relates generally to identity management, and more specifically to shared account access via phishing-resistant authenticators.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

### SUMMARY

A method for managing access by an identity management system to an account accessible to a set of multiple users is described. The method may include receiving, at an authorization server of the identity management system and from a user device, a request to access the account accessible to the set of multiple users, verifying, via one or more communications with an authenticator application of the identity management system on the user device, an identity of a user associated with the user device based on the request being for access to the account accessible to the set of multiple users, evaluating, at an access server of the identity management system, a policy associated with the account accessible to the set of multiple users, generating, based on the policy indicating that the user is authorized to access the account, a signed assertion that the user is authorized to access the account accessible to the set of multiple users, the signed assertion generated using a private key stored at a hardware vault of the identity management system and associated with the account, and transmitting the signed assertion to the user device.

An identity management system for managing access to an account accessible to a set of multiple users is described. The identity management system may include one or more memories storing processor executable code, and one or more processors coupled with the one or more memories. The one or more processors may individually or collectively be operable to execute the code to cause the identity management system to receive, at an authorization server of the identity management system and from a user device, a request to access the account accessible to the set of multiple users, verify, via one or more communications with an authenticator application of the identity management system on the user device, an identity of a user associated with the user device based on the request being for access to the account accessible to the set of multiple users, evaluate, at an access server of the identity management system, a policy associated with the account accessible to the set of multiple users, generate, based on the policy indicating that the user is authorized to access the account, a signed assertion that the user is authorized to access the account accessible to the set of multiple users, the signed assertion generated using a private key stored at a hardware vault of the identity management system and associated with the account, and transmit the signed assertion to the user device.

Another identity management system is described. The identity management system may include means for receiving, at an authorization server of the identity management system and from a user device, a request to access the account accessible to the set of multiple users, means for verifying, via one or more communications with an authenticator application of the identity management system on the user device, an identity of a user associated with the user device based on the request being for access to the account accessible to the set of multiple users, means for evaluating, at an access server of the identity management system, a policy associated with the account accessible to the set of multiple users, means for generating, based on the policy indicating that the user is authorized to access the account, a signed assertion that the user is authorized to access the account accessible to the set of multiple users, the signed assertion generated using a private key stored at a hardware vault of the identity management system and associated with the account, and means for transmitting the signed assertion to the user device.

A non-transitory computer-readable medium storing code for managing access to an account accessible to a set of multiple users is described. The code may include instructions executable by one or more processors to receive, at an authorization server of the identity management system and from a user device, a request to access the account accessible to the set of multiple users, verify, via one or more communications with an authenticator application of the identity management system on the user device, an identity of a user associated with the user device based on the request being for access to the account accessible to the set of multiple users, evaluate, at an access server of the identity management system, a policy associated with the account accessible to the set of multiple users, generate, based on the policy indicating that the user is authorized to access the account, a signed assertion that the user is authorized to access the account accessible to the set of multiple users, the signed assertion generated using a private key stored at a hardware vault of the identity management system and associated with the account, and transmit the signed assertion to the user device.

In some examples of the method, identity management systems, and non-transitory computer-readable medium described herein, evaluating the policy may include operations, features, means, or instructions for determining whether the user may be assigned one or more tasks involving access to the account accessible to the set of multiple users, where the policy indicates that access to the account may be based on task assignments.

In some examples of the method, identity management systems, and non-transitory computer-readable medium described herein, evaluating the policy may include operations, features, means, or instructions for identifying inclusion of the user in the set of multiple users having access to the account in the policy, where the policy indicates that the account may be accessible to the set of multiple users.

Some examples of the method, identity management systems, and non-transitory computer-readable medium described herein may further include operations, features, means, or instructions for transmitting, after evaluating the policy, an authentication challenge requesting provision of one or more authentication factors by the user and via the authenticator application based on the policy indicating the one or more authentication factors.

Some examples of the method, identity management systems, and non-transitory computer-readable medium described herein may further include operations, features, means, or instructions for transmitting, in response to the request to access the account, an authentication challenge to the user device, where the authentication challenge invokes the authenticator application on the user device.

Some examples of the method, identity management systems, and non-transitory computer-readable medium described herein may further include operations, features, means, or instructions for receiving a second request to authenticate the user based on the authentication challenge invoking the authenticator application and on the request being to access the account accessible to the set of multiple users.

In some examples of the method, identity management systems, and non-transitory computer-readable medium described herein, verifying the identity of the user may include operations, features, means, or instructions for transmitting an authentication challenge to the authenticator application on the user device and receiving, in response to the authentication challenge, a signed authentication challenge and a request to authorize the user to access the account accessible to the set of multiple users, where evaluating the policy may be based on receiving the request to authorize the user to access the account.

In some examples of the method, identity management systems, and non-transitory computer-readable medium described herein, the signed authentication challenge may be received based on provision of one or more authentication factors at the authenticator application on the user device by the user.

Some examples of the method, identity management systems, and non-transitory computer-readable medium described herein may further include operations, features, means, or instructions for verifying that the signed authentication challenge may be signed by the authenticator application.

Some examples of the method, identity management systems, and non-transitory computer-readable medium described herein may further include operations, features, means, or instructions for receiving, in response to the signed assertion, a second request to exchange the signed assertion for an authorization code, transmitting the authorization code in response to the second request, receiving, in response to the authorization code, a third request to exchange the authorization code for an access token usable to access the account, and transmitting the access token in response to the third request.

In some examples of the method, identity management systems, and non-transitory computer-readable medium described herein, the access token may be short-lived and cryptographically bound to the user device.

Some examples of the method, identity management systems, and non-transitory computer-readable medium described herein may further include operations, features, means, or instructions for receiving, from the authenticator application on the user device, one or more messages indicating device information associated with the user device, where evaluating the policy is based at least in part on the device information.

### BRIEF DESCRIPTION OF THE DRAWINGS

FIGS. 1 and 2 illustrate examples of computing systems that support shared account access via phishing-resistant authenticators in accordance with aspects of the present disclosure.

FIGS. 3-5 show examples of process flows that support shared account access via phishing-resistant authenticators in accordance with aspects of the present disclosure.

FIG. 6 shows a block diagram of an apparatus that supports shared account access via phishing-resistant authenticators in accordance with aspects of the present disclosure.

FIG. 7 shows a block diagram of a shared account access manager that supports shared account access via phishing-resistant authenticators in accordance with aspects of the present disclosure.

FIG. 8 shows a diagram of a system including a device that supports shared account access via phishing-resistant authenticators in accordance with aspects of the present disclosure.

FIGS. 9 and 10 show flowcharts illustrating methods that support shared account access via phishing-resistant authenticators in accordance with aspects of the present disclosure.

### DETAILED DESCRIPTION

Some accounts may be shared by multiple users. For example, multiple users may use a same credential (e.g., username and password, passkey, etc.) to access shared accounts, workloads, service accounts, or the like. In some cases, the multiple users may have access to the credential. That is, each user may know or store the credential on their own user device. In such cases, it may be difficult to audit which user(s) access the shared account, rotate the credential to prevent unauthorized access to the shared account, revoke access of individual users to the shared account, or the like. As an example, a first user may be terminated from an organization associated with the shared account. To revoke the access by the first user, the organization may change and redistribute the credential to all of the other users. Changing and redistributing the credential may be an inconvenience for the users, especially in cases where access is revoked from users frequently, and it may be difficult to redistribute the credential in a secure manner.

In some other cases, the credential may be a static secret or token (e.g., a bearer token) stored at a vault of a security system. To prevent the credential from being stolen, the security system may rotate the credential, such as on a per-use or periodic basis. However, rotating the credential may cause race conditions at the shared account. For example, a first user may use the credential to log in, the security system may rotate the credential, then a second user may use the rotated credential to log in. Because the credential was rotated, the first user may now have an invalid credential and be unable to access the shared account. That is, the first user and the second user may not be able to concurrently access the shared account.

In yet another case, some protocols (e.g., Secure Protection Identity Framework for Everyone (SPIFFE)) may support authenticated access to shared accounts via device-bound credentials. For example, after authenticating access to a shared account, a security system may deploy a credential used to access the shared account to a device (e.g., a client or agent machine), where the credential is bound to that device. However, deploying credentials to devices may not be applicable to dynamic environments in which devices that users access the shared account through change, or users who access the shared account change. Additionally, deploying credentials to devices may be less secure than storing the credentials at the security system and refraining from providing credentials to users directly.

Techniques described herein may support improved access to shared accounts. For example, an identity management system may use both user authentication and policy evaluation to ensure that users accessing a shared account are authorized and that the access is recorded. The identity management system may communicate with an authenticator application on a user device to perform user authentication (e.g., verify an identity of the user). Based on authenticating a user, the identity management system may perform a policy evaluation to determine whether the user is permitted to access the shared account. For example, the identity management system may evaluate whether the user is assigned to a task that involves the shared account, whether the user is designated as having access to the shared account, or the like. The identity management system may generate a signed assertion that the user is permitted to access the shared account. For example, the identity management system may generate the signed assertion using a key associated with the shared account stored at a hardware vault of the identity management system. The user may exchange the signed assertion for a token (e.g., a short-lived token) usable to access the shared account.

By both verifying the identity of the user and that the user is permitted to access the shared account, techniques described herein support improved security of access to shared accounts compared to other shared account access techniques, including sharing static credentials, storing and rotating static credentials, and deploying device-bound credentials. For example, because the key used to generate the signed assertion is stored at the hardware vault of the identity management system and only used to generate signed assertions for authorized users, the identity management system may not have to rotate the key or rotate the key less frequently compared to a stored static credential. Accordingly, techniques described herein support concurrent access to shared accounts. Additionally, techniques described herein may support access to the shared account by a dynamic set of devices. That is, because the access to the shared account is based on user identity and credentials are stored at the identity management system (e.g., rather than provided to devices), techniques described herein may support access to the shared account by variable, flexible groups of devices.

Aspects of the disclosure are initially described in the context of computing systems. Aspects of the disclosure are also described in the context of process flows. Aspects of the disclosure are further illustrated by and described with reference to apparatus diagrams, system diagrams, and flowcharts that relate to shared account access via phishing-resistant authenticators.

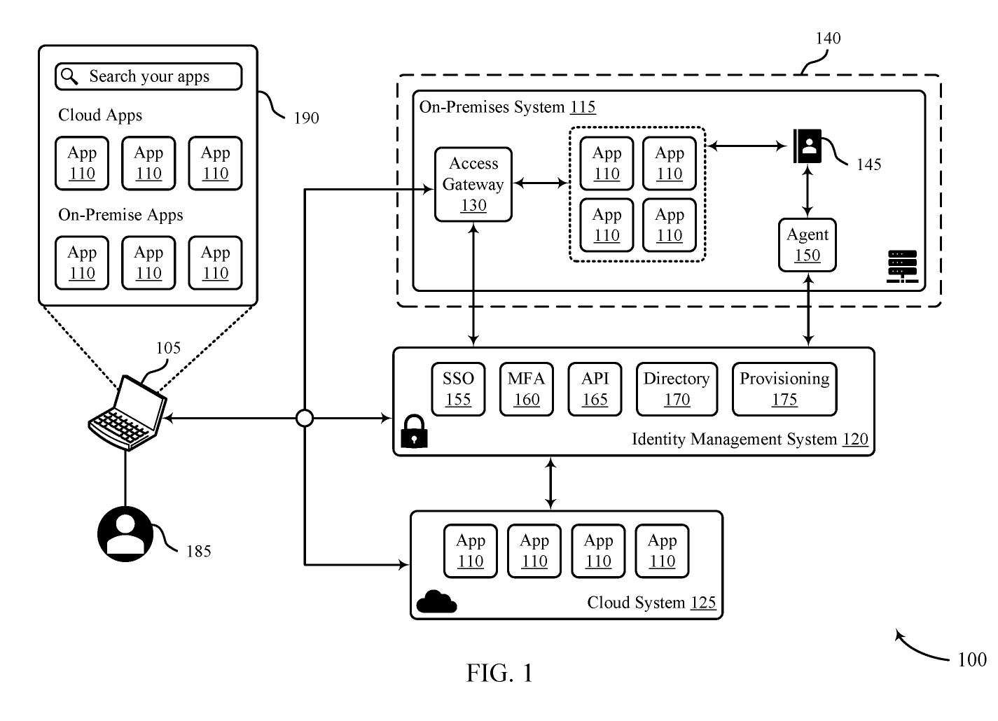

FIG. 1 illustrates an example of a computing system 100 that supports shared account access via phishing-resistant authenticators in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user’s request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user’s request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user’s identity by comparing the credentials provided by the user 185 to credentials associated with the user’s account. For example, one or more credentials associated with the user’s account may be registered with the IdP (e.g., previously registered, or otherwise authorized for authentication of the user’s identity via the IdP). The IdP may generate a security token (such as a SAML token or Oath 2.0 token) containing information associated with the identity and/or authentication status of the user 185 based on successful authentication of the user’s identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization’s APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee’s accounts and revoke the employee’s access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

The identity management system 120 may manage access to a shared account. The identity management system 120 may receive, at an authorization server and from a computing device 105, a request to access a shared account. The identity management system 120 may verify, via communications with an authenticator application on the computing device 105, an identity of a user 185 associated with the computing device 105 based on the request being for access to the shared account. The identity management system 120 may evaluate, at an access server of the identity management system 120, a policy associated with the shared account. The identity management system 120 may generate, based on the policy indicating that the user 185 is authorized to access the shared account, a signed assertion that the user 185 is authorized to access the shared account, the signed assertion generated using a private key stored at a hardware vault of the identity management system 120 and associated with the shared account. The identity management system 120 may transmit the signed assertion to the computing device 105.

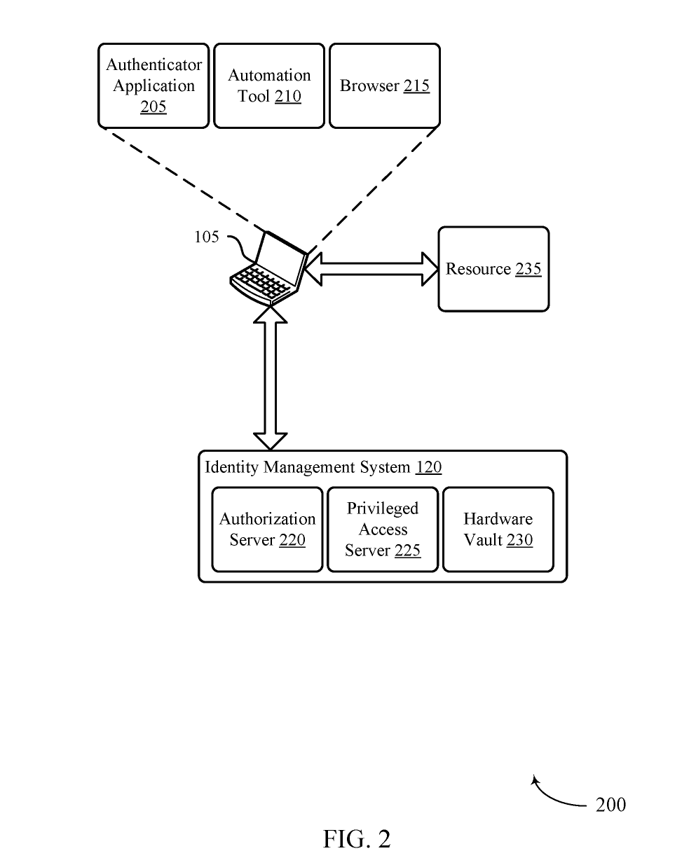

FIG. 2 shows an example of a computing system 200 that supports shared account access via phishing-resistant authenticators in accordance with aspects of the present disclosure. The computing system 200 may implement or be implemented by aspects of the computing system 100. For example, the computing system 200 may include a computing device 105 and an identity management system 120, which may be examples of corresponding devices and systems described with reference to FIG. 1.

The computing device 105—which may be referred to as a user device herein—may include an authenticator application 205, an automation tool 210, and a browser 215. The authenticator application 205 may be an example of a phishing-resistant authenticator. For example, the authenticator application 205 may be an example of Okta FastPass, an authenticator involving smart cards (e.g., Personal Identity Verification (PIV) or Common Access Card (CAC)), Fast Identity Online 2.0 (FIDO2), or the like. The authenticator application 205 may support phishing resistance, proof of possession of a device, user verification through inherence or knowledge factors, or the like. The authenticator application 205 may be an example of a client-side application of the identity management system 120. For example, the authenticator application 205 may be an application of the identity management system 120 installed on the computing device 105.

The identity management system 120 may include an authorization server 220, a privileged access server 225, and a hardware vault 230. The authorization server 220 may receive and respond to authorization requests. For example, the authorization server 220 may communicate with the authenticator application 205 on the computing device 105 to receive authorization requests and issue authentication challenges.

The privileged access server 225 may evaluate access policies for accounts. For example, the privileged access server 225 may store access policies associated with shared accounts. Additionally, or alternatively, the privileged access server 225 may perform just-in-time (JIT) evaluations. The privileged access server 225 may, based on access policies and/or JIT evaluations, trigger additional authentication (e.g., via the authorization server 220, the authenticator application 205, or both), generate signed assertions used to access shared accounts, or both. For example, the privileged access server 225 may communicate with the hardware vault 230 to generate signed assertions. The hardware vault 230 may be an example of a hardware security module (HSM). For example, the hardware vault 230 may be an example of a physical computing device or system that stores and guards secrets, including digital keys, credentials, and the like. The hardware vault 230 may perform one or more functions to provide signatures using the stored secrets, including signatures for assertions. The identity management system 120 may issue asymmetric cryptographic credentials (e.g., private and public keys, encryption and decryption keys, signing and verifying keys, etc.) to workload accounts, where the hardware vault 230 may store the private keys for those credentials in a cloud system (such as the cloud system 125 as described with reference to FIG. 1).

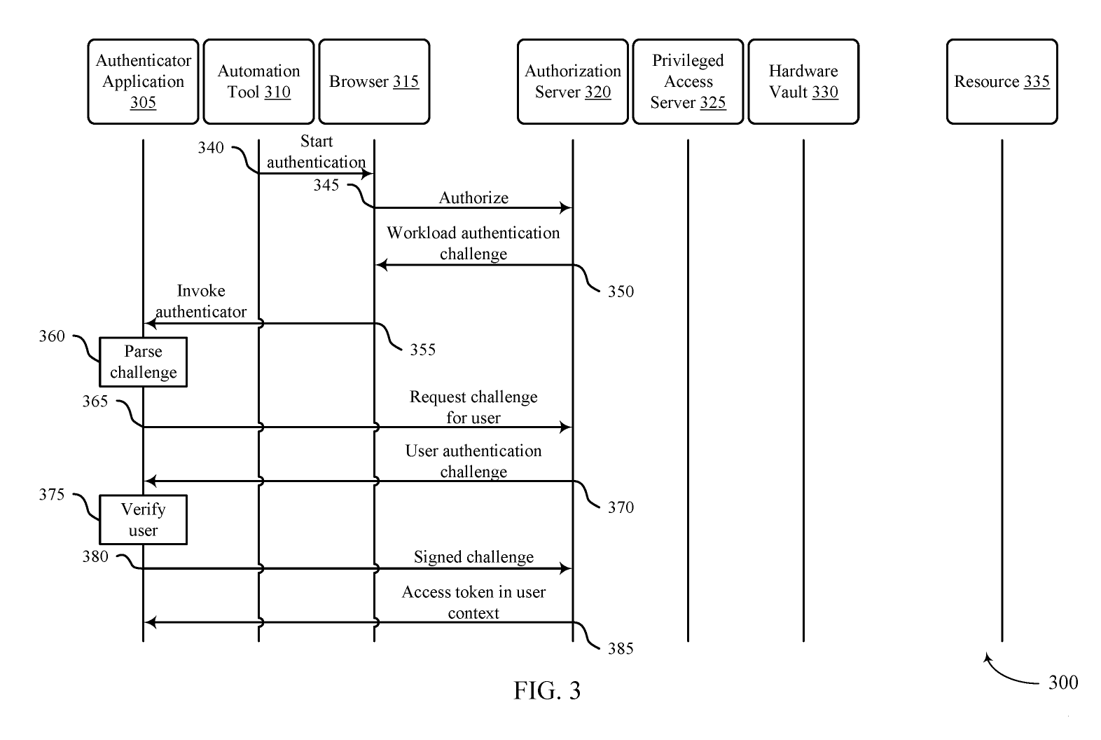

The computing device 105 and the identity management system 120 may perform one or more communications to enable a user of the computing device 105 to access a resource 235. For example, the resource 235 may be an example of a shared account or workload, or of a resource 235 accessible through access to a shared account or workload. As used herein, shared accounts or workloads may refer to accounts associated with or accessible by multiple users. For example, an account accessible to multiple users may refer to a shared account, workload, non-human identity account, service account, or the like. Communications between the computing device 105 and the identity management system 120 to enable a user to access the resource 235 may be described in greater detail elsewhere herein, including with reference to FIGS. 3-5.

FIG. 3 shows an example of a process flow 300 that supports shared account access via phishing-resistant authenticators in accordance with aspects of the present disclosure. The process flow 300 may implement or be implemented by aspects of the computing system 100, the computing system 200, or both. For example, the process flow 300 may illustrate operations of an authenticator application 305, an automation tool 310, a browser 315, an authorization server 320, a privileged access server 325, a hardware vault 330, and a resource 335, which examples of corresponding devices or systems as described with reference to FIG. 2. The authenticator application 305, the automation tool 310, and the browser 315 may be included or accessed on a computing device, such as the computing device 105 as described with reference to FIGS. 1 and 2. Additionally, the authorization server 320, the privileged access server 325, and the hardware vault 330 may be parts of an identity management system, such as the identity management system 120 as described with reference to FIGS. 1 and 2.

In the following description of the process flow 300, the operations performed at the authenticator application 305, the automation tool 310, the browser 315, the authorization server 320, the privileged access server 325, the hardware vault 330, and the resource 335 may be performed in different orders or at different times than shown. While the operations of the process flow 300 are illustrated and described as being performed by the authenticator application 305, the automation tool 310, the browser 315, the authorization server 320, the privileged access server 325, the hardware vault 330, and the resource 335, the operations described herein may be performed at one or more other devices or systems. Additionally, or alternatively, some operations may be omitted from the process flow 300 and other operations may be added to the process flow 300.

At 340, the automation tool 310 may start authentication via the browser 315. For example, the automation tool 310 may identify that a user is attempting to log in to a workload (e.g., a shared account) on the browser 315 and, based on identifying the login attempt, trigger authentication. At 345, the browser 315 may transmit a request to authorize the login to the authorization server 320. For example, the authorization server 320 may receive a request to access an account accessible to multiple users (e.g., a workload or a shared account) from a user device (e.g., via the browser 315 on the user device).

In response to the request, at 350, the authorization server 320 may transmit a workload authentication challenge. The workload authentication challenge may, at 355, cause the browser 315 to invoke the authenticator application 305. For example, the authorization server 320 may transmit, in response to the request to access the account, an authentication challenge to the user device, where the authentication challenge invokes the authenticator application 305 on the user device. The authenticator application 305 may, at 360, parse the authentication challenge. For example, the authenticator application 305 may parse the authentication challenge and detect, based on the parsing, that the authentication challenge is to authenticate a workload. Put another way, the authenticator application 305 and the authorization server 320 may identify (e.g., based on the parsing and the request, respectively) that the request is for a workload or a shared account.

At 365, after detecting that the authentication challenge is to authenticate the workload, the authenticator application 305 may request a challenge for a user. For example, the authorization server 320 may receive a second request to authenticate the user based on the authentication challenge invoking the authenticator application 305 and on the request being to access the account accessible to the multiple users (e.g., the workload). That is, rather than authenticating the access to the workload, the authenticator application 305 may request to authenticate an identity of the user attempting to log in to (e.g., access, impersonate, etc.) the workload. The user may be previously enrolled in and authenticated to the authenticator application 305. The authenticator application 305 and the authorization server 320 may verify, via exchanging one or more communications, an identity of a user associated with the user device (e.g., that the authenticator application 305 is on) based on the request being for access to the account accessible to multiple users (e.g., being a workload).

At 370, to verify the identity of the user, the authorization server 320 may transmit a user authentication challenge. At 375, the authenticator application 305 may verify the user. For example, the authenticator application 305 may obtain proof of possession of a device, inherence or knowledge factors, or the like that verify the identity of the user. Based on verifying the identity of the user, at 380, the authenticator application 305 may transmit a signed challenge to the authorization server 320. For example, the authenticator application 305 may sign, using a key associated with the authenticator application 305, the authentication challenge transmitted by the authorization server 320 at 370. The signed challenge may also include a request to authorize the user to access the account accessible to the multiple users (e.g., the workload). Additionally, the signed challenge may include posture signals associated with the user device (e.g., device information). For example, the authenticator application 305 may transmit signals about the device that the access request originates from. That is, the authenticator application 305 may indicate, to the authorization server 320, device information about the user device (e.g., the computing device 105, as described with reference to FIG. 1.). The authenticator application 305 may generate and transmit the signed authentication challenge based on provision of one or more authentication factors at the authenticator application 305 on the user device by the user.

In response to the signed authentication challenge, the authorization server 320 may provide an access token in a user context at 385. For example, the authorization server 320 may verify that the signed authentication challenge is signed by the authenticator application 305 and transmit, in response, an access token. The access token may indicate that an identity of the user is verified, but may not grant access to the workload. That is, the user may use the access token in the user context to access one or more accounts specific to the user (e.g., non-shared accounts, individual accounts, etc.), but not the workload.

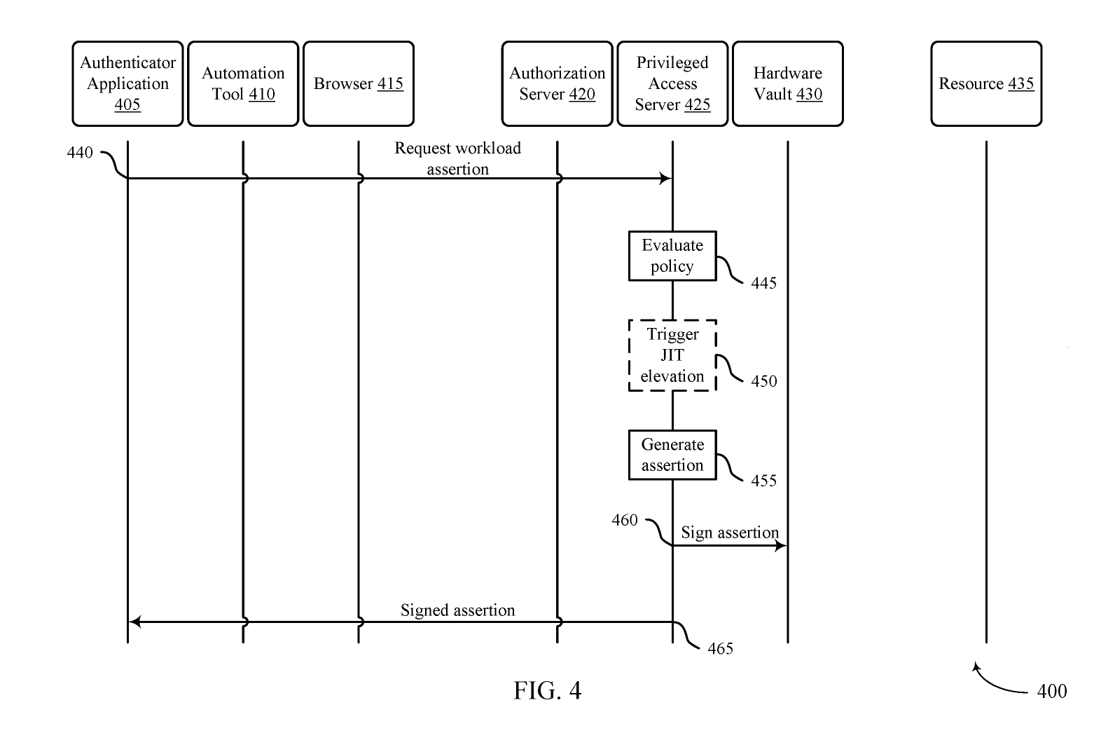

FIG. 4 shows an example of a process flow 400 that supports shared account access via phishing-resistant authenticators in accordance with aspects of the present disclosure. The process flow 400 may implement or be implemented by aspects of the computing system 100, the computing system 200, or both. For example, the process flow 400 may illustrate operations of an authenticator application 405, an automation tool 410, a browser 415, an authorization server 420, a privileged access server 425, a hardware vault 430, and a resource 435, which examples of corresponding devices or systems as described with reference to FIG. 2. The authenticator application 405, the automation tool 410, and the browser 415 may be included or accessed on a computing device, such as the computing device 105 as described with reference to FIGS. 1 and 2. Additionally, the authorization server 420, the privileged access server 425, and the hardware vault 430 may be parts of an identity management system, such as the identity management system 120 as described with reference to FIGS. 1 and 2.

In the following description of the process flow 400, the operations performed at the authenticator application 405, the automation tool 410, the browser 415, the authorization server 420, the privileged access server 425, the hardware vault 430, and the resource 435 may be performed in different orders or at different times than shown. While the operations of the process flow 400 are illustrated and described as being performed by the authenticator application 405, the automation tool 410, the browser 415, the authorization server 420, the privileged access server 425, the hardware vault 430, and the resource 435, the operations described herein may be performed at one or more other devices or systems. Additionally, or alternatively, some operations may be omitted from the process flow 400 and other operations may be added to the process flow 400.

In some aspects, the process flow 400 may include operations occurring after or in response to operations of the process flow 300. For example, the operations of the process flow 400 may occur after authenticating the user via the operations of the process flow 300. After verifying the user, an identity management system including the authorization server 420, the privileged access server 425, and the hardware vault 430 may authorize the user to access a shared account or a workload.

At 440, the authenticator application 405 may request a workload assertion from the privileged access server 425. For example, after verifying the identity of the user via the operations of the process flow 300, the authenticator application 405 may request that the verified user is authorized to access the workload. Based on receiving the request, at 445, the privileged access server 425 may evaluate a policy. For example, the privileged access server 425 may evaluate a policy associated with the workload to determine whether the user is authorized to access the workload. Put another way, the privileged access server 425 may verify whether the user is authorized to access the workload based on evaluating a policy associated with the workload. In some examples, the privileged access server 425 may evaluate the policy based on information about the user device (e.g., the computing device 105, as described with reference to FIG. 1) that the request originates from. That is, the privileged access server 425 may perform a policy evaluation based on the workload that the user is attempting to access, as well as based on device information (e.g., posture signals) associated with the user device and provided by the authenticator application 405 (e.g., at 380 of FIG. 3).

The policy may include tasks assigned to users that involve the workload. That is, evaluating the policy may include determining whether the user is assigned one or more tasks involving access to the account accessible to the multiple users (e.g., the workload), where the policy indicates that access to the account is based on task assignments. For example, the policy may indicate that if the user is assigned a project or task associated with access to the workload (e.g., requiring the workload to complete the project or task), the user may be authorized to access the workload. Alternatively, the policy may indicate that if the user is absent an assignment to a project or task that involves access to the workload, the user may not be authorized to access the workload. In some other examples, the policy may indicate that the workload is accessible to multiple users. That is, the policy may include a list of users that are authorized to access the workload. In such examples, evaluating the policy may include identifying an inclusion or absence of the user in the list of users having authorized access to the account.

In some examples, at 450, the privileged access server 425 may trigger a JIT elevation. As used herein, JIT elevation or access may refer to access privileges (e.g., to the workload or shared account) being granted for predetermined periods of time, on an as-needed basis (e.g., based on whether users are assigned tasks involving access to the workload), or the like. For example, the workload may not have standing privileges for users, where users can always access the workload regardless of need. Instead, the workload may be accessed as needed, such as when the workload is to be used for completion of tasks assigned to users. The JIT elevation may involve one or more workflows that are automated, including checking if the workload matches work items (e.g., tasks or projects) assigned to the user.

After evaluating the policy, in some examples, the privileged access server 425 may determine that additional authentication is necessary to access the workload. For example, the policy may indicate that, to access the workload, the user may be authenticated via one or more authentication factors. If the user did not provide such authentication factors during the operations of the process flow 300, the privileged access server 425 may indicate to the authorization server 420 that additional authentication is requested. The authorization server 420 may transmit an authentication challenge requesting provision of one or more authentication factors by the user and via the authenticator application 405 based on the policy indicating the one or more authentication factors.

At 455, if the user is permitted to access the workload, the privileged access server 425 may generate an assertion. The assertion may be that the user is authorized to access the workload. At 460, the privileged access server 425 may also generate a signature for the assertion via the hardware vault 430. For example, the privileged access server 425 may generate, based on the policy indicating that the user is authorized to access the account, a signed assertion that the user is authorized to access the account accessible to the multiple users (e.g., the workload), the signed assertion generated using a private key stored at a hardware vault 430 of the identity management system and associated with the account. That is, the signed assertion may be in the context of the workload (e.g., rather than a user context). At 465, the privileged access server 425 may output the signed assertion to the authenticator application 405. That is, the privileged access server 425 may transmit the signed assertion to the user device.

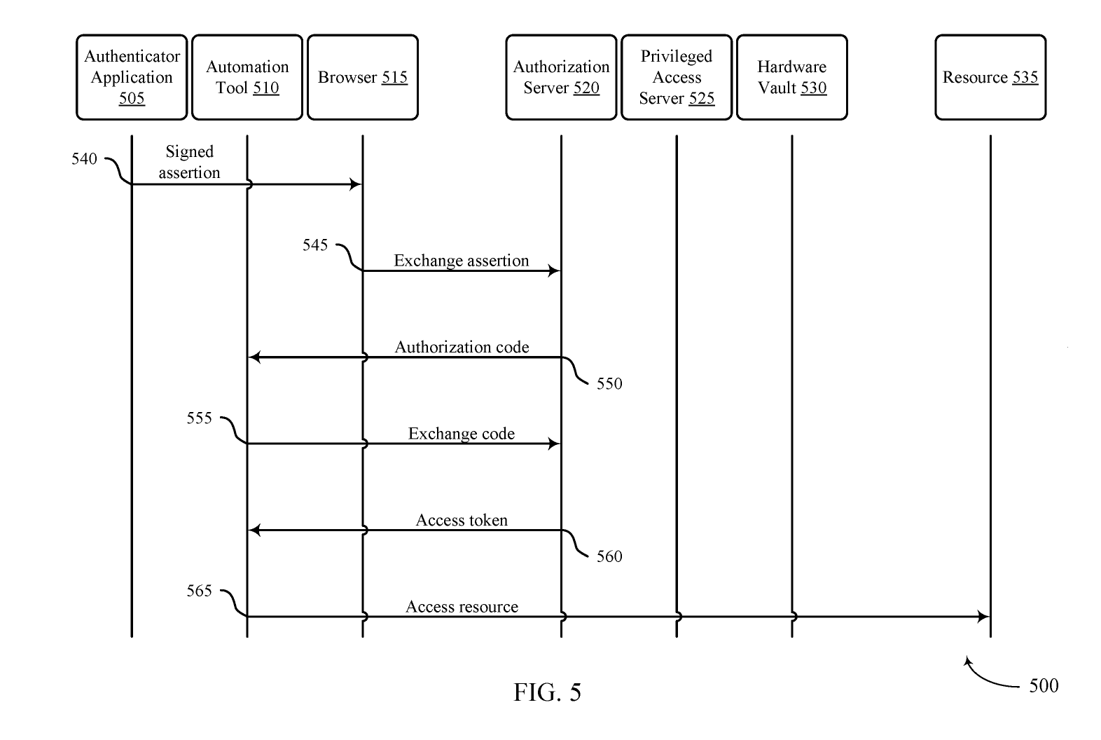

FIG. 5 shows an example of a process flow 500 that supports shared account access via phishing-resistant authenticators in accordance with aspects of the present disclosure. The process flow 500 may implement or be implemented by aspects of the computing system 100, the computing system 200, or both. For example, the process flow 500 may illustrate operations of an authenticator application 505, an automation tool 510, a browser 515, an authorization server 520, a privileged access server 525, a hardware vault 530, and a resource 535, which examples of corresponding devices or systems as described with reference to FIG. 2.

In the following description of the process flow 500, the operations performed at the authenticator application 505, the automation tool 510, the browser 515, the authorization server 520, the privileged access server 525, the hardware vault 530, and the resource 535 may be performed in different orders or at different times than shown. While the operations of the process flow 500 are illustrated and described as being performed by the authenticator application 505, the automation tool 510, the browser 515, the authorization server 520, the privileged access server 525, the hardware vault 530, and the resource 535, the operations described herein may be performed at one or more other devices or systems. Additionally, or alternatively, some operations may be omitted from the process flow 500 and other operations may be added to the process flow 500.

In some aspects, the process flow 500 may include operations occurring after or in response to operations of the process flow 400. For example, the operations of the process flow 500 may occur after verifying that the user is authorized to access the shared account or the workload and after providing the signed assertion to the user device via the operations of the process flow 400. After providing the signed assertion, the devices and systems described with respect to the process flow 500 may perform one or more communications to exchange the signed assertion for an access token usable to access the shared account or the workload.

At 540, the authenticator application 505 may transmit the signed assertion to the browser 515. At 545, after receiving the signed assertion, the browser 515 may exchange the assertion via the authorization server 520. For example, the authorization server 520 may receive, in response to the signed assertion (e.g., at 465 of the process flow 400), a request to exchange the signed assertion for an authorization code. At 550, in response to the request, the authorization server 520 may transmit an authorization code to the automation tool 510.

At 555, the automation tool 510 may exchange the authorization code via the authorization server 520. For example, in response to the authorization code, the authorization server 520 may receive a request to exchange the authorization code for an access token usable to access the workload. At 560, the authorization server 520 may transmit an access token to the automation tool 510. In some examples, the access token may be short-lived and cryptographically bound to the user device. For example, the access token may be an example of or involve a device bound session credential (DBSC), demonstrating proof of possession (DPoP), or the like. The automation tool 510 may use the access token to access the resource 535 at 565. For example, the resource 535 may be the workload itself, or a resource accessible through the workload.

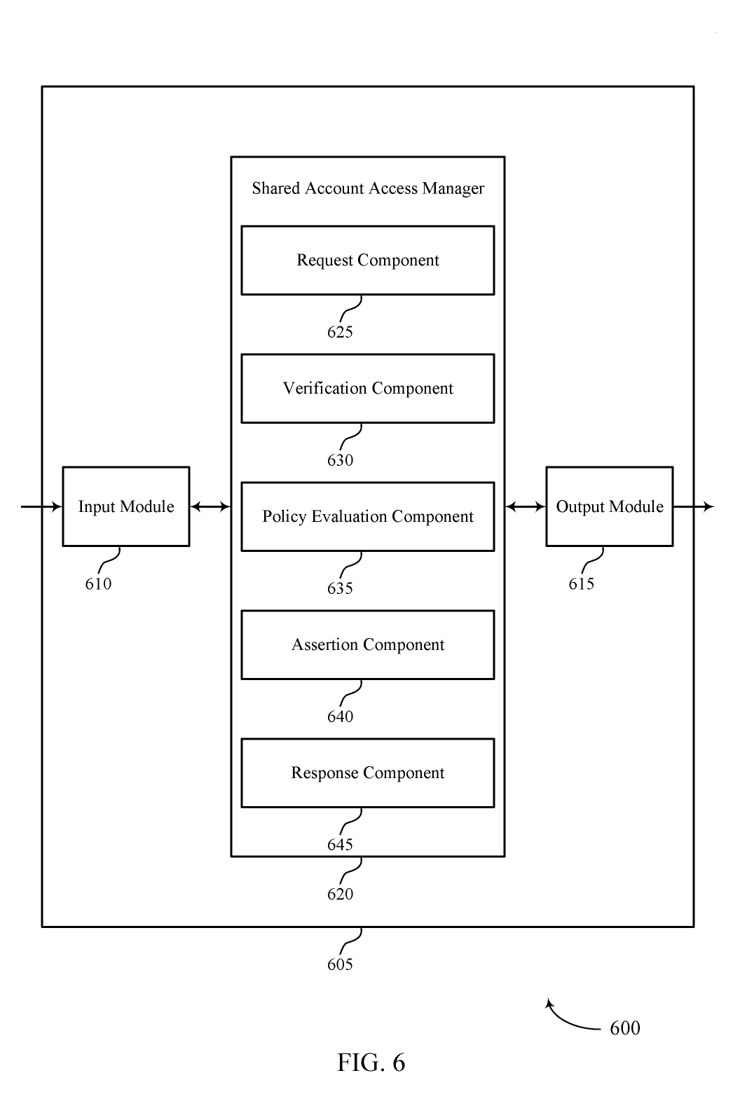

FIG. 6 shows a block diagram 600 of a device 605 that supports shared account access via phishing-resistant authenticators in accordance with aspects of the present disclosure. The device 605 may include an input module 610, an output module 615, and a shared account access manager 620. The device 605, or one or more components of the device 605 (e.g., the input module 610, the output module 615, the shared account access manager 620), may include at least one processor, which may be coupled with at least one memory, to support the described techniques. Each of these components may be in communication with one another (e.g., via one or more buses).

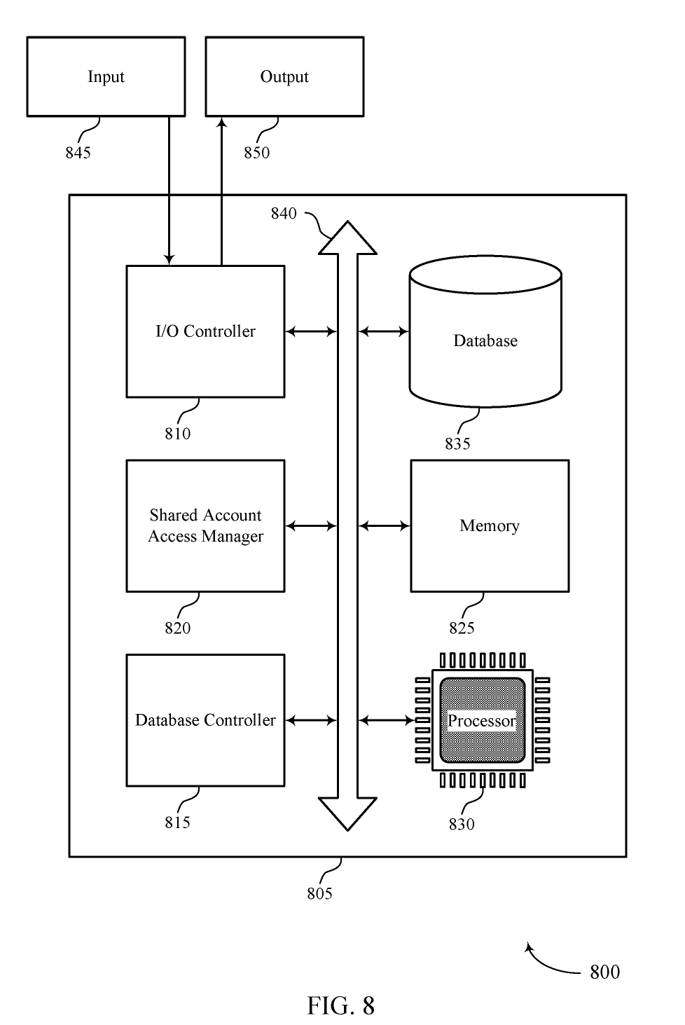

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the shared account access manager 620 to support shared account access via phishing-resistant authenticators. In some cases, the input module 610 may be a component of an input/output (I/O) controller 810 as described with reference to FIG. 8.

The output module 615 may manage output signals for the device 605. For example, the output module 615 may receive signals from other components of the device 605, such as the shared account access manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the shared account access manager 620 may include a request component 625, a verification component 630, a policy evaluation component 635, an assertion component 640, a response component 645, or any combination thereof. In some examples, the shared account access manager 620, or various components thereof, may be configured to perform various operations (e.g., receiving, monitoring, transmitting) using or otherwise in cooperation with the input module 610, the output module 615, or both. For example, the shared account access manager 620 may receive information from the input module 610, send information to the output module 615, or be integrated in combination with the input module 610, the output module 615, or both to receive information, transmit information, or perform various other operations as described herein.

The shared account access manager 620 may support managing access in accordance with examples as disclosed herein. The request component 625 may be configured to support receiving, at an authorization server of the identity management system and from a user device, a request to access the account accessible to the set of multiple users. The verification component 630 may be configured to support verifying, via one or more communications with an authenticator application of the identity management system on the user device, an identity of a user associated with the user device based on the request being for access to the account accessible to the set of multiple users. The policy evaluation component 635 may be configured to support evaluating, at an access server of the identity management system, a policy associated with the account accessible to the set of multiple users. The assertion component 640 may be configured to support generating, based on the policy indicating that the user is authorized to access the account, a signed assertion that the user is authorized to access the account accessible to the set of multiple users, the signed assertion generated using a private key stored at a hardware vault of the identity management system and associated with the account. The response component 645 may be configured to support transmitting the signed assertion to the user device.

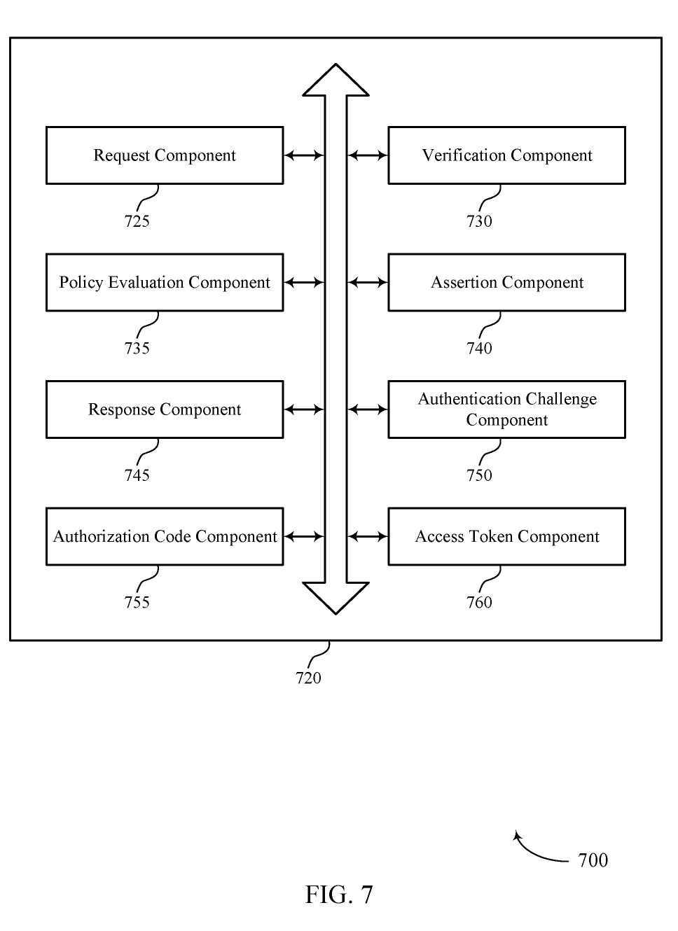

FIG. 7 shows a block diagram 700 of a shared account access manager 720 that supports shared account access via phishing-resistant authenticators in accordance with aspects of the present disclosure. The shared account access manager 720 may be an example of aspects of a shared account access manager or a shared account access manager 620, or both, as described herein. The shared account access manager 720, or various components thereof, may be an example of means for performing various aspects of shared account access via phishing-resistant authenticators as described herein. For example, the shared account access manager 720 may include a request component 725, a verification component 730, a policy evaluation component 735, an assertion component 740, a response component 745, an authentication challenge component 750, an authorization code component 755, an access token component 760, or any combination thereof. Each of these components, or components of subcomponents thereof (e.g., one or more processors, one or more memories), may communicate, directly or indirectly, with one another (e.g., via one or more buses).

The shared account access manager 720 may support managing access in accordance with examples as disclosed herein. The request component 725 may be configured to support receiving, at an authorization server of the identity management system and from a user device, a request to access the account accessible to the set of multiple users. The verification component 730 may be configured to support verifying, via one or more communications with an authenticator application of the identity management system on the user device, an identity of a user associated with the user device based on the request being for access to the account accessible to the set of multiple users. The policy evaluation component 735 may be configured to support evaluating, at an access server of the identity management system, a policy associated with the account accessible to the set of multiple users. The assertion component 740 may be configured to support generating, based on the policy indicating that the user is authorized to access the account, a signed assertion that the user is authorized to access the account accessible to the set of multiple users, the signed assertion generated using a private key stored at a hardware vault of the identity management system and associated with the account. The response component 745 may be configured to support transmitting the signed assertion to the user device.

In some examples, to support evaluating the policy, the policy evaluation component 735 may be configured to support determining whether the user is assigned one or more tasks involving access to the account accessible to the set of multiple users, where the policy indicates that access to the account is based on task assignments.

In some examples, to support evaluating the policy, the policy evaluation component 735 may be configured to support identifying inclusion of the user in the set of multiple users having access to the account in the policy, where the policy indicates that the account is accessible to the set of multiple users.

In some examples, the authentication challenge component 750 may be configured to support transmitting, after evaluating the policy, an authentication challenge requesting provision of one or more authentication factors by the user and via the authenticator application based on the policy indicating the one or more authentication factors.

In some examples, the authentication challenge component 750 may be configured to support transmitting, in response to the request to access the account, an authentication challenge to the user device, where the authentication challenge invokes the authenticator application on the user device.

In some examples, the request component 725 may be configured to support receiving a second request to authenticate the user based on the authentication challenge invoking the authenticator application and on the request being to access the account accessible to the set of multiple users.

In some examples, to support verifying the identity of the user, the authentication challenge component 750 may be configured to support transmitting an authentication challenge to the authenticator application on the user device. In some examples, to support verifying the identity of the user, the request component 725 may be configured to support receiving, in response to the authentication challenge, a signed authentication challenge and a request to authorize the user to access the account accessible to the set of multiple users, where evaluating the policy is based on receiving the request to authorize the user to access the account.

In some examples, the signed authentication challenge is received based on provision of one or more authentication factors at the authenticator application on the user device by the user.

In some examples, the verification component 730 may be configured to support verifying that the signed authentication challenge is signed by the authenticator application.

In some examples, the request component 725 may be configured to support receiving, in response to the signed assertion, a second request to exchange the signed assertion for an authorization code. In some examples, the authorization code component 755 may be configured to support transmitting the authorization code in response to the second request. In some examples, the request component 725 may be configured to support receiving, in response to the authorization code, a third request to exchange the authorization code for an access token usable to access the account. In some examples, the access token component 760 may be configured to support transmitting the access token in response to the third request.

In some examples, the access token is short-lived and cryptographically bound to the user device.

In some examples, the policy evaluation component 735 may be configured to support receiving, from the authenticator application on the user device, one or more messages indicating device information associated with the user device, where evaluating the policy is based at least in part on the device information.

FIG. 8 shows a diagram of a system 800 including a device 805 that supports shared account access via phishing-resistant authenticators in accordance with aspects of the present disclosure. The device 805 may be an example of or include components of a device 605 as described herein. The device 805 may include components for bi-directional voice and data communications including components for transmitting and receiving communications, such as a shared account access manager 820, an I/O controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting shared account access via phishing-resistant authenticators). The processor 830 may be an example of a single processor or multiple processors. For example, the device 805 may include one or more processors 830.

The shared account access manager 820 may support managing access in accordance with examples as disclosed herein. For example, the shared account access manager 820 may be configured to support receiving, at an authorization server of the identity management system and from a user device, a request to access the account accessible to the set of multiple users. The shared account access manager 820 may be configured to support verifying, via one or more communications with an authenticator application of the identity management system on the user device, an identity of a user associating with the user device based on the request being for access to the account accessible to the set of multiple users. The shared account access manager 820 may be configured to support evaluating, at an access server of the identity management system, a policy associated with the account accessible to the set of multiple users. The shared account access manager 820 may be configured to support generating, based on the policy indicating that the user is authorized to access the account, a signed assertion that the user is authorized to access the account accessible to the set of multiple users, the signed assertion generated using a private key stored at a hardware vault of the identity management system and associated with the account. The shared account access manager 820 may be configured to support transmitting the signed assertion to the user device.

By including or configuring the shared account access manager 820 in accordance with examples as described herein, the device 805 may support techniques for improved access management for shared accounts.

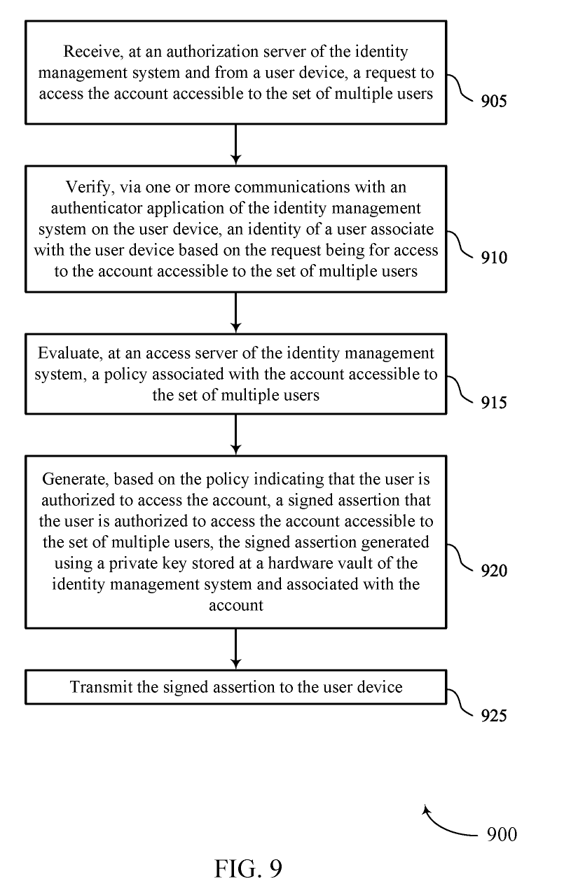

FIG. 9 shows a flowchart illustrating a method 900 that supports shared account access via phishing-resistant authenticators in accordance with aspects of the present disclosure. The operations of the method 900 may be implemented by a device or its components as described herein. For example, the operations of the method 900 may be performed by a device as described with reference to FIGS. 1-8. In some examples, a device may execute a set of instructions to control the functional elements of the device to perform the described functions. Additionally, or alternatively, the device may perform aspects of the described functions using special-purpose hardware.

At 905, the method may include receiving, at an authorization server of the identity management system and from a user device, a request to access the account accessible to the set of multiple users. The operations of 905 may be performed in accordance with examples as disclosed herein. In some examples, aspects of the operations of 905 may be performed by a request component 725 as described with reference to FIG. 7.

At 910, the method may include verifying, via one or more communications with an authenticator application of the identity management system on the user device, an identity of a user associated with the user device based on the request being for access to the account accessible to the set of multiple users. The operations of 910 may be performed in accordance with examples as disclosed herein. In some examples, aspects of the operations of 910 may be performed by a verification component 730 as described with reference to FIG. 7.

At 915, the method may include evaluating, at an access server of the identity management system, a policy associated with the account accessible to the set of multiple users. The operations of 915 may be performed in accordance with examples as disclosed herein. In some examples, aspects of the operations of 915 may be performed by a policy evaluation component 735 as described with reference to FIG. 7.

At 920, the method may include generating, based on the policy indicating that the user is authorized to access the account, a signed assertion that the user is authorized to access the account accessible to the set of multiple users, the signed assertion generated using a private key stored at a hardware vault of the identity management system and associated with the account. The operations of 920 may be performed in accordance with examples as disclosed herein. In some examples, aspects of the operations of 920 may be performed by an assertion component 740 as described with reference to FIG. 7.

At 925, the method may include transmitting the signed assertion to the user device. The operations of 925 may be performed in accordance with examples as disclosed herein. In some examples, aspects of the operations of 925 may be performed by a response component 745 as described with reference to FIG. 7.

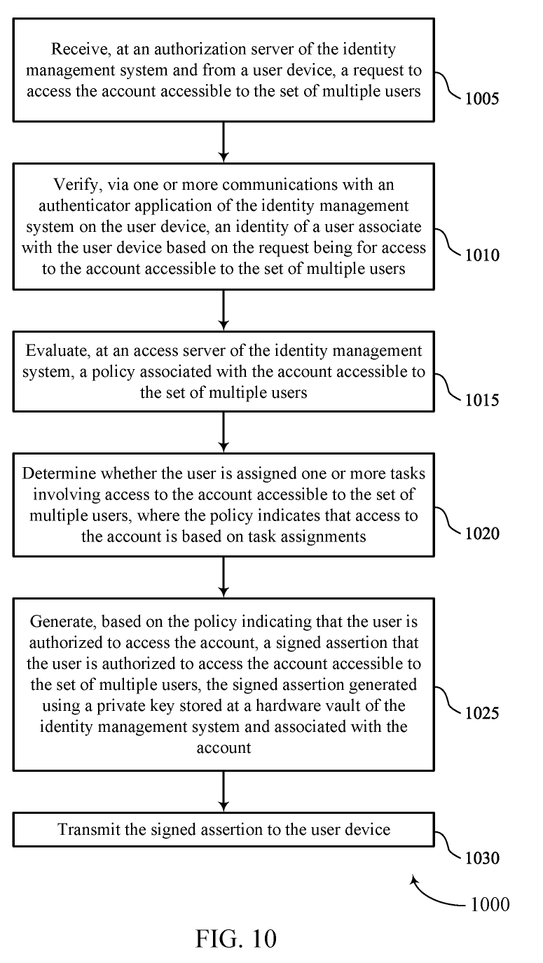

FIG. 10 shows a flowchart illustrating a method 1000 that supports shared account access via phishing-resistant authenticators in accordance with aspects of the present disclosure. The operations of the method 1000 may be implemented by a device or its components as described herein. For example, the operations of the method 1000 may be performed by a device as described with reference to FIGS. 1-8. In some examples, a device may execute a set of instructions to control the functional elements of the device to perform the described functions. Additionally, or alternatively, the device may perform aspects of the described functions using special-purpose hardware.

At 1005, the method may include receiving, at an authorization server of the identity management system and from a user device, a request to access the account accessible to the set of multiple users. The operations of 1005 may be performed in accordance with examples as disclosed herein. In some examples, aspects of the operations of 1005 may be performed by a request component 725 as described with reference to FIG. 7.

At 1010, the method may include verifying, via one or more communications with an authenticator application of the identity management system on the user device, an identity of a user associated with the user device based on the request being for access to the account accessible to the set of multiple users. The operations of 1010 may be performed in accordance with examples as disclosed herein. In some examples, aspects of the operations of 1010 may be performed by a verification component 730 as described with reference to FIG. 7.

At 1015, the method may include evaluating, at an access server of the identity management system, a policy associated with the account accessible to the set of multiple users. The operations of 1015 may be performed in accordance with examples as disclosed herein. In some examples, aspects of the operations of 1015 may be performed by a policy evaluation component 735 as described with reference to FIG. 7.

At 1020, the method may include determining whether the user is assigned one or more tasks involving access to the account accessible to the set of multiple users, where the policy indicates that access to the account is based on task assignments. The operations of 1020 may be performed in accordance with examples as disclosed herein. In some examples, aspects of the operations of 1020 may be performed by a policy evaluation component 735 as described with reference to FIG. 7.

At 1025, the method may include generating, based on the policy indicating that the user is authorized to access the account, a signed assertion that the user is authorized to access the account accessible to the set of multiple users, the signed assertion generated using a private key stored at a hardware vault of the identity management system and associated with the account. The operations of 1025 may be performed in accordance with examples as disclosed herein. In some examples, aspects of the operations of 1025 may be performed by an assertion component 740 as described with reference to FIG. 7.

At 1030, the method may include transmitting the signed assertion to the user device. The operations of 1030 may be performed in accordance with examples as disclosed herein. In some examples, aspects of the operations of 1030 may be performed by a response component 745 as described with reference to FIG. 7.

The following provides an overview of aspects of the present disclosure:

Aspect 1: A method for managing access, at an identity management system, to an account accessible to a plurality of users, comprising: receiving, at an authorization server of the identity management system and from a user device, a request to access the account accessible to the plurality of users; verifying, via one or more communications with an authenticator application of the identity management system on the user device, an identity of a user associated with the user device based at least in part on the request being for access to the account accessible to the plurality of users; evaluating, at an access server of the identity management system, a policy associated with the account accessible to the plurality of users; generating, based at least in part on the policy indicating that the user is authorized to access the account, a signed assertion that the user is authorized to access the account accessible to the plurality of users, the signed assertion generated using a private key stored at a hardware vault of the identity management system and associated with the account; and transmitting the signed assertion to the user device.

Aspect 2: The method of aspect 1, wherein evaluating the policy comprises: determining whether the user is assigned one or more tasks involving access to the account accessible to the plurality of users, wherein the policy indicates that access to the account is based at least in part on task assignments.

Aspect 3: The method of any of aspects 1 through 2, wherein evaluating the policy comprises: identifying inclusion of the user in the plurality of users having access to the account in the policy, wherein the policy indicates that the account is accessible to the plurality of users.

Aspect 4: The method of any of aspects 1 through 3, further comprising: transmitting, after evaluating the policy, an authentication challenge requesting provision of one or more authentication factors by the user and via the authenticator application based at least in part on the policy indicating the one or more authentication factors.

Aspect 5: The method of any of aspects 1 through 4, further comprising: transmitting, in response to the request to access the account, an authentication challenge to the user device, wherein the authentication challenge invokes the authenticator application on the user device.

Aspect 6: The method of aspect 5, further comprising: receiving a second request to authenticate the user based at least in part on the authentication challenge invoking the authenticator application and on the request being to access the account accessible to the plurality of users.

Aspect 7: The method of any of aspects 1 through 6, wherein verifying the identity of the user comprises: transmitting an authentication challenge to the authenticator application on the user device; and receiving, in response to the authentication challenge, a signed authentication challenge and a request to authorize the user to access the account accessible to the plurality of users, wherein evaluating the policy is based at least in part on receiving the request to authorize the user to access the account.

Aspect 8: The method of aspect 7, wherein the signed authentication challenge is received based at least in part on provision of one or more authentication factors at the authenticator application on the user device by the user.

Aspect 9: The method of any of aspects 7 through 8, further comprising: verifying that the signed authentication challenge is signed by the authenticator application.

Aspect 10: The method of any of aspects 1 through 9, further comprising: receiving, in response to the signed assertion, a second request to exchange the signed assertion for an authorization code; transmitting the authorization code in response to the second request; receiving, in response to the authorization code, a third request to exchange the authorization code for an access token usable to access the account; and transmitting the access token in response to the third request.

Aspect 11: The method of aspect 10, wherein the access token is short-lived and cryptographically bound to the user device.

Aspect 12: The method of any of aspects 1 through 11, further comprising: receiving, from the authenticator application on the user device, one or more messages indicating device information associated with the user device, wherein evaluating the policy is based at least in part on the device information.

Aspect 13: An identity management system, to an account accessible to a plurality of users for managing access, comprising one or more memories storing processor-executable code, and one or more processors coupled with the one or more memories and individually or collectively operable to execute the code to cause the identity management system, to an account accessible to a plurality of users to perform a method of any of aspects 1 through 12.

Aspect 14: An identity management system, to an account accessible to a plurality of users for managing access, comprising at least one means for performing a method of any of aspects 1 through 12.

Aspect 15: A non-transitory computer-readable medium storing code for managing access, the code comprising instructions executable by one or more processors to perform a method of any of aspects 1 through 12.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for managing access, at an identity management system, to an account accessible to a plurality of users, comprising:
receiving, at an authorization server of the identity management system and from a user device, a request to access the account accessible to the plurality of users;
verifying, via one or more communications with an authenticator application of the identity management system on the user device, an identity of a user associated with the user device based at least in part on the request being for access to the account accessible to the plurality of users;
evaluating, at an access server of the identity management system, a policy associated with the account accessible to the plurality of users;
generating, based at least in part on the policy indicating that the user is authorized to access the account, a signed assertion that the user is authorized to access the account accessible to the plurality of users, the signed assertion generated using a private key stored at a hardware vault of the identity management system and associated with the account; and
transmitting the signed assertion to the user device.

2. The method of claim 1, wherein evaluating the policy comprises:
determining whether the user is assigned one or more tasks involving access to the account accessible to the plurality of users, wherein the policy indicates that access to the account is based at least in part on task assignments.

3. The method of claim 1, wherein evaluating the policy comprises:
identifying inclusion of the user in the plurality of users having access to the account in the policy, wherein the policy indicates that the account is accessible to the plurality of users.

4. The method of claim 1, further comprising:
transmitting, after evaluating the policy, an authentication challenge requesting provision of one or more authentication factors by the user and via the authenticator application based at least in part on the policy indicating the one or more authentication factors.

5. The method of claim 1, further comprising:
transmitting, in response to the request to access the account, an authentication challenge to the user device, wherein the authentication challenge invokes the authenticator application on the user device.

6. The method of claim 5, further comprising:
receiving a second request to authenticate the user based at least in part on the authentication challenge invoking the authenticator application and on the request being to access the account accessible to the plurality of users.

7. The method of claim 1, wherein verifying the identity of the user comprises:
transmitting an authentication challenge to the authenticator application on the user device; and
receiving, in response to the authentication challenge, a signed authentication challenge and a request to authorize the user to access the account accessible to the plurality of users, wherein evaluating the policy is based at least in part on receiving the request to authorize the user to access the account.

8. The method of claim 7, wherein the signed authentication challenge is received based at least in part on provision of one or more authentication factors at the authenticator application on the user device by the user.

9. The method of claim 7, further comprising:
verifying that the signed authentication challenge is signed by the authenticator application.

10. The method of claim 1, further comprising:
receiving, in response to the signed assertion, a second request to exchange the signed assertion for an authorization code;
transmitting the authorization code in response to the second request;
receiving, in response to the authorization code, a third request to exchange the authorization code for an access token usable to access the account; and
transmitting the access token in response to the third request.

11. The method of claim 10, wherein the access token is short-lived and cryptographically bound to the user device.

12. The method of claim 1, further comprising:
receiving, from the authenticator application on the user device, one or more messages indicating device information associated with the user device, wherein evaluating the policy is based at least in part on the device information.

13. An identity management system for managing access to an account accessible to a plurality of users, comprising:
one or more memories storing processor-executable code; and
one or more processors coupled with the one or more memories and individually or collectively operable to execute the code to cause the identity management system to:
receive, at an authorization server of the identity management system and from a user device, a request to access the account accessible to the plurality of users;
verify, via one or more communications with an authenticator application of the identity management system on the user device, an identity of a user associated with the user device based at least in part on the request being for access to the account accessible to the plurality of users;
evaluate, at an access server of the identity management system, a policy associated with the account accessible to the plurality of users;
generate, based at least in part on the policy indicating that the user is authorized to access the account, a signed assertion that the user is authorized to access the account accessible to the plurality of users, the signed assertion generated using a private key stored at a hardware vault of the identity management system and associated with the account; and
transmit the signed assertion to the user device.

14. The identity management system of claim 13, wherein, to evaluate the policy, the one or more processors are individually or collectively operable to execute the code to cause the identity management system to:
determine whether the user is assigned one or more tasks involving access to the account accessible to the plurality of users, wherein the policy indicates that access to the account is based at least in part on task assignments.

15. The identity management system of claim 13, wherein, to evaluate the policy, the one or more processors are individually or collectively operable to execute the code to cause the identity management system to:
identify inclusion of the user in the plurality of users having access to the account in the policy, wherein the policy indicates that the account is accessible to the plurality of users.

16. The identity management system of claim 13, wherein the one or more processors are individually or collectively further operable to execute the code to cause the identity management system to:
transmit, after evaluating the policy, an authentication challenge requesting provision of one or more authentication factors by the user and via the authenticator application based at least in part on the policy indicating the one or more authentication factors.

17. The identity management system of claim 13, wherein the one or more processors are individually or collectively further operable to execute the code to cause the identity management system to:
transmit, in response to the request to access the account, an authentication challenge to the user device, wherein the authentication challenge invokes the authenticator application on the user device.

18. A non-transitory computer-readable medium storing code for managing access to an account accessible to a plurality of users, the code comprising instructions executable by one or more processors to:
receive, at an authorization server of an identity management system and from a user device, a request to access the account accessible to the plurality of users;
verify, via one or more communications with an authenticator application of the identity management system on the user device, an identity of a user associated with the user device based at least in part on the request being for access to the account accessible to the plurality of users;
evaluate, at an access server of the identity management system, a policy associated with the account accessible to the plurality of users;
generate, based at least in part on the policy indicating that the user is authorized to access the account, a signed assertion that the user is authorized to access the account accessible to the plurality of users, the signed assertion generated using a private key stored at a hardware vault of the identity management system and associated with the account; and
transmit the signed assertion to the user device.

19. The non-transitory computer-readable medium of claim 18, wherein the instructions to evaluate the policy are executable by the one or more processors to:
determine whether the user is assigned one or more tasks involving access to the account accessible to the plurality of users, wherein the policy indicates that access to the account is based at least in part on task assignments.

20. The non-transitory computer-readable medium of claim 18, wherein the instructions to evaluate the policy are executable by the one or more processors to:
identify inclusion of the user in the plurality of users having access to the account in the policy, wherein the policy indicates that the account is accessible to the plurality of users.
